(19) United States
(12) Patent Application Publication
(10) Pub. No.: US 2006/0250568 A1
(43) Pub. Date: Nov. 9, 2006

(54) Stratified-phase-separated composite comprising a polymer and a liquid and method of manufacturing the same

(76) Inventors: Roel Penterman, Eindhoven (NL); Stephen Isadore Klink, Eindhoven (NL); Joost Peter Andre Vogels, Eindhoven (NL); Dirk Jan Broer, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/567,231

(22) PCT Filed: Jul. 5, 2004
(86) PCT No.: PCT/IB04/51122

§ 371 Date: Feb. 3, 2006

(30) Foreign Application Priority Data
Aug. 6, 2003 (EP) 03102445.8

(51) Int. Cl. C09K 19/02

(52) U.S. Cl. 349/183

(57) ABSTRACT

A polymeric stratified-phase-separated composite (6) which is mechanically robust and simple to manufacture comprises a film of liquid (7), a layer of polymerized material (9) covering the thin film of liquid and supporting members (11) formed of polymerized material and extending from the layer of polymerized material through the thin film of liquid. The supporting members extend onto selected first regions (5b) of a substrate surface (5). The substrate surface has, laid our in accordance with a predetermined pattern, selected first (5b) and second (5a) regions. The first are functionalized for selective accumulation of the liquid. In one embodiment the first and second regions are regions of high and low affinity for polymerizable material respectively. In another, a difference in rate of polymerization is induced by using for example different concentrations of polymerization inhibitor in the first and second regions.

The invention relates to a polymeric stratified-phase-separated composite.

The invention further relates to a method of manufacturing a polymeric stratified-phase-separated composite.

Composites of the type mentioned in the opening paragraph are known in the art as such. WO 02/42832, for example, discloses such a polymeric stratified-phase-separated composite as part of a liquid crystal display laminate. The polymeric stratified-phase-separated composite disclosed therein comprises a polymeric layer covering a liquid crystal layer and has supporting members which extend from the polymeric layer through the liquid crystal layer onto a substrate surface.

The polymeric stratified-phase-separable material is manufactured by means of a method wherein a layer of photo-polymerizable stratified-phase-separable material is subjected to two successive exposures with ultraviolet light. The first exposure is a pattern-wise exposure in which the supporting member are formed, the second exposure is a flood exposure wherein the liquid crystal layer and the polymeric layer are formed. The known method is rather cumbersome. For example, having to perform two exposures one of which pattern-wise is not very attractive. Furthermore, the inventors have found that the mechanical robustness of the known stratified-phase-separated composite manufactured in accordance with the known method leaves room for improvement; application of lateral or shear stresses often leads to failure of the stratified-phase-separated composite. Such stresses develop in particular when the laminate is flexed, such flexure being required in flexible or more particular rollable displays, or is heat stressed e.g. to temperatures above 50° C.

It is an object of the invention to provide, inter alia, a polymeric stratified-phase-separated composite which is simple to manufacture and is mechanically robust, in particular when lateral or shear stresses are applied rendering such composites particularly suitable for applications where flexibility is required. The polymeric stratified-phase-separated composite is to be mechanically robust in the sense of maintaining mechanical integrity and maintaining a substantially constant liquid film thickness when mechanically stressed.

These and other objects are achieved by a polymeric stratified-phase-separated composite comprising a film of a liquid, a layer of a polymerized material covering the film of liquid and supporting members formed of the polymerized material and extending from the layer of polymerized material through the film of liquid, the polymeric stratified-phase-separated composite being provided, with its film of liquid side, on a substrate surface having in accordance with a predetermined pattern selected first and second regions, the first regions being functionalized for selective accumulation of the polymerized material and the second regions being functionalized for selective accumulation of the liquid, wherein the supporting members extend selectively onto the selected first regions.

The selective formation of supporting members onto the first regions of the substrate surface leads to a controlled and self-aligned formation of supporting members in accordance with a predetermined pattern. Being self-aligned, the process of stratified-phase-separation itself need not employ patterning means. More specifically, compared to the prior art described above, the number of exposures is reduced from two exposures, one of which is patterned, to one flood exposure. Thus a more simple method of manufacturing is obtained. Furthermore, the range of methods and phase-separable materials from which a stratified-phase-separated composite can be obtained is extended to include methods which are not easily combined with such patterning means, solvent and temperature-induced phase-separation being examples of such methods.

The stratified-phase-separated composite in accordance with the invention is also mechanically more robust since supporting members adhere more strongly to the substrate surface than conventional stratified-phase-separated composites. In the manufacture of conventional stratified-phase-separated composites the polymerized and polymerizable material has a relatively low affinity for the substrate surface at least relative to that of the liquid. If this were not the case the layer of polymerized material would form adjacent the substrate surface instead of on top of the liquid film or stratified phase-separation may not occur at all. On the other hand, a low affinity and hence a low strength of adhesion adversely affects the mechanical robustness of the composite. Thus, in conventional stratified-phase-separated composites, the strength of adhesion to the substrate is the result of a compromise. In the stratified-phase-separated composites in accordance with the invention such compromise is not required; on the contrary, the requirements of stratified-phase-separation and strength of adhesion now run parallel.

In one embodiment of the polymeric stratified-phase-separated composite in accordance with the invention, the selected first and second regions are regions of high and low affinity, respectively, for polymerizable material from which the polymerized material of the supporting members is obtained.

To their surprise, the inventors found that providing a patterned substrate surface having high and low affinity regions for polymerizable material from which the polymerized material of the supporting members is obtained, results in selective accumulation of polymerized material adjacent the high affinity regions considering that the rate of polymerization is, at least in the initial stages of polymerization the same within any plane at a given distance from the substrate surface.

In the context of the present invention, “high” and “low” are first and foremost relative terms, specifically “high affinity” means an affinity higher than “low affinity” and vice versa. If a region has a (relatively) high affinity for the polymerizable material from which the polymeric material of the stratified-phase-separated composite is obtained, it adheres (relatively) strongly to such region.

The term “polymerizable material” includes “monomeric material”, “prepolymeric material” and “partially polymerized material”.

Increasing the affinity (adhesion) of a surface to obtain a high affinity region or decreasing the affinity of a surface as well as methods of doing the same pattern-wise are well-established in the art. For example, in the art of adhesives, in particular glues, a lot of art is available to the skilled artisan for this purpose. Also, if a surface has high affinity, it wets such surface well. A measure of high affinity is thus obtained by measuring the contact angle of a candidate stratified-phase-separable material on a candidate substrate surface. In general, adhesion may be changed by applying a surface treatment or by adding an affinity modifying agent such as an adhesion promoter. High affinity may be realized by means of physisorption or chemisorption.

In a preferred embodiment of the polymeric stratified-phase-separated composite in accordance with the invention the regions of high affinity are functionalized with chemically reactive groups and the regions of low affinity are not so functionalized, and regions of the supporting members are functionalized with chemically reactive groups, and chemically reactive groups of the substrate surface and the supporting members having reacted with one another to form covalent bonds. Covalently bonding the supporting members to the substrate surface provides a particularly robust stratified-phase-separated composite.

In one embodiment of the polymeric stratified-phase-separated composite in accordance with the invention, the first and second regions are functionalized for facilitating a high and low rate of polymerization respectively. The term “low rate of polymerization” includes zero rate of polymerization. If the rate of polymerization is high and low respectively, polymerized material selectively accumulates adjacent the first regions and accordingly liquid accumulates selectively adjacent the second regions.

A differential rate of polymerization of polymerizable material adjacent such regions is conveniently formed by means of a low and high concentration of polymerization inhibitor respectively. The term “low concentration” includes a zero concentration. Polymerization inhibitors are well known in the art as such. Such inhibitors are typically used to inhibit polymerization at a time when this is not desired. Functionalizing the second regions with polymer inhibitor, the rate of polymerization in such regions is decreased relative to the first regions and accordingly liquid selectively accumulates in the second and polymerized material in the first regions. As is well known in the art, which inhibitor to use depends on the type of polymerization. For example, generally in case of a cationic polymerization anionic moieties will be effective as inhibitors whereas radical scavengers are effective inhibitors for free-radical polymerizations. When an inhibitor is used a dye for setting up an intensity gradient within the layer to be phase-separated can be dispensed with because the inhibitor provides the driving force for stratification. Obviously, this effect is also operative if the stratified phase separated composite does not have supporting members.

The polymerization inhibitor may be accommodated in and/or on the substrate. The extent of inhibition in terms of the distance from the substrate up to which polymerization is inhibited may be selected as desired. This can be achieved by selecting a polymerization inhibitor which diffuses to a greater or lesser extent out of the substrate into the layer being polymerized thus setting up a gradient of inhibitor within the layer being polymerized. Obviously, time and temperature can be used to control the rate of diffusion. Diffusion of inhibitor from the substrate to the layer to be polymerized may be effectively prevented by using an inhibitor which is chemically bonded, or preferably, covalently bonded to the substrate material. This is particularly convenient if the substrate material is polymeric and the inhibitor is co-polymerized with the polymeric material.

Alternatively, a differential rate of polymerization may be achieved using a differential concentration of polymerization initiator. Such initiators are well known in the art. A high concentration of initiator in the first region increases the polymerization rate of polymerizable material adjacent such region thus resulting in selective accumulation of polymerized material in such region.

An advantageous embodiment of the stratified-phase-separated composite in accordance with the invention is one wherein the polymeric stratified-phase-separated composite is a photo-polymeric stratified-phase-separated composite. In case stratified-phase-separation is performed by means of photo-polymerization, a pattern-wise exposure can be dispensed with.

The liquid film is thin; it has a thickness typically less than about 5 mm, or more specifically, about 1 mm. It may even have a thickness of about 500 μm, or more particular about 200 μm or less. The minimum thickness is about 0.5 μm or more particular about 1.0 μm.

Polymeric stratified-phase separated composites, methods of obtaining such and materials from which such composites can be obtained are known in the art as such. See e.g. U.S. Pat. No. 6,486,932, WO 02/42832, WO 02/48281, 0248282 and 02/48783. Such known composites, methods and materials can be suitably used in the present invention.

The stratified-phase-separated composite in combination with the substrate forms a liquid-filled container having a film of liquid. The supporting members allow the liquid film to have a constant thickness even when pressure is applied thereon. Such containers are particularly useful in display applications based on display effects involving a liquid. Examples include liquid crystal displays, electro-wetting and electrophoretic displays.

In a broad sense, the shape of individual supporting members, in particular the height and diameter thereof and the total volume occupied is not critical to the invention and is determined by the particular application of the liquid-filled container. Convenient shapes are pillars and walls. Generally, to maximize the amount of liquid which the container can hold, the total volume occupied by the supporting members is to be minimized. However, the smaller the volume the less mechanically robust.

In a particular embodiment of the polymeric stratified-phase-separated composite in accordance with the invention, the supporting members are formed as walls partitioning the film of liquid into a plurality of separate liquid-filled pockets.

Having a wall structure which creates separate liquid-filled pockets provides a liquid-filled container having a thickness which is essentially constant even when considerably pressure is applied at right angles to the liquid layer because the fluid cannot escape from its pocket. In many applications this is a significant advantage. For example, it allows flexible or even rollable (liquid crystal) displays to be made. Also, locally applied pressure to the sheet has hardly effect on the thickness of the thin liquid film which is of advantage in touch screen applications. In particular, it allows touch sensing means such as touch sensing circuitry to be provided on the side facing away from the viewer. This aspect is independent of the presence of first and second regions. It is applicable to any stratified-phase-separated composite having supporting members in the forms of walls partitioning the liquid film into separate liquid-filled pockets.

The stratified-phase-separated composite in accordance with the invention may, in a broad sense, contain any type of liquid. The liquid may be an inorganic liquid such as water or may be of organic origin. The liquid may be an oil, a paste, a cream, a foam, an ink, an emulsion, a colloid suspension or other form liquid containing particles such as an electrophoretic medium. In a particular advantageous embodiment, the liquid is a liquid crystal.

More in particular, the liquid crystal in the stratified-phase-separated composite is switchable between a first and a second state having different optical properties, wherein at least one of the first and second state is an oriented state. Orienting a liquid crystal layer can be done by conventional means such as electric and magnetic fields. Preferably, orientation is achieved using an alignment layer. Accordingly, in a preferred embodiment the substrate surface is, on a side facing the film of liquid, provided with an alignment layer.

When filled with liquid crystal, the liquid-filled container which results in combination with the substrate, may be conveniently used in a liquid crystal display. Accordingly, a convenient embodiment of the stratified-phase-separated composite in accordance with the invention is a liquid crystal display comprising such a composite.

Liquid crystal displays in accordance with the invention are thin yet mechanically robust. In fact, the thickness of the display can be so small so as to allow the display to be flexible while maintaining robustness even allowing roll-to-roll manufacturing.

With respect to LC effects which may be used, suitable liquid crystals and other layers which are or may be required in the display such as polarizer layers, electrode layers reference is made to WO 02/42832 which is hereby incorporated by reference.

The invention also relates to a method of manufacturing a polymeric stratified-phase-separated composite.

In accordance with the invention, the method is a method of manufacturing a polymeric stratified-phase-separated composite comprising a film of a liquid, a layer of polymerized material covering the film of liquid and supporting members formed of polymerized material and extending from the layer of polymerized material through the film of liquid onto selected first regions of a substrate surface, the method comprising:

providing a substrate surface having, in accordance with a predetermined pattern, selected first and second regions, the first regions being functionalized for selective accumulation of the polymerized material and the second regions being functionalized for selective accumulation of the liquid

providing onto the substrate surface, a layer of polymerizable stratified-phase-separable material;

obtaining the polymeric stratified-phase-separated composite from the polymerizable stratified-phase-separable material by inducing polymerization of the polymerizable stratified-phase-separable material at least at locations where the layer of polymerizable stratified-phase-separable material is adjacent to the selected first regions.

The presence of the selected first and second regions (which may be high and low affinity regions as described above or regions of differential polymerization rate) makes the formation of the supporting members in accordance with the predetermined pattern a self-aligned process thus making the process of manufacturing the stratified-phase-separated composite more simple. Also, the range of stratified-phase-separable materials which can be suitably used to obtain stratified-phase-separated composites in accordance with the invention is extended to include for example thermal-induced phase-separable materials and solvent-induced phase-separable materials as such materials are difficult to phase-separate pattern-wise.

In a preferred embodiment of the method in accordance with the invention, the polymerizable stratified-phase-separable material is photo-polymerizable.

Use of a photo-polymeric stratified-phase-separated composite obviates the need to do a pattern-wise exposure. Accordingly, the method comprises inducing photo-polymerization by means of a flood exposure.

These and other aspects of the invention will be apparent from and elucidated with reference to the drawings and examples described hereinafter.

In the drawings:

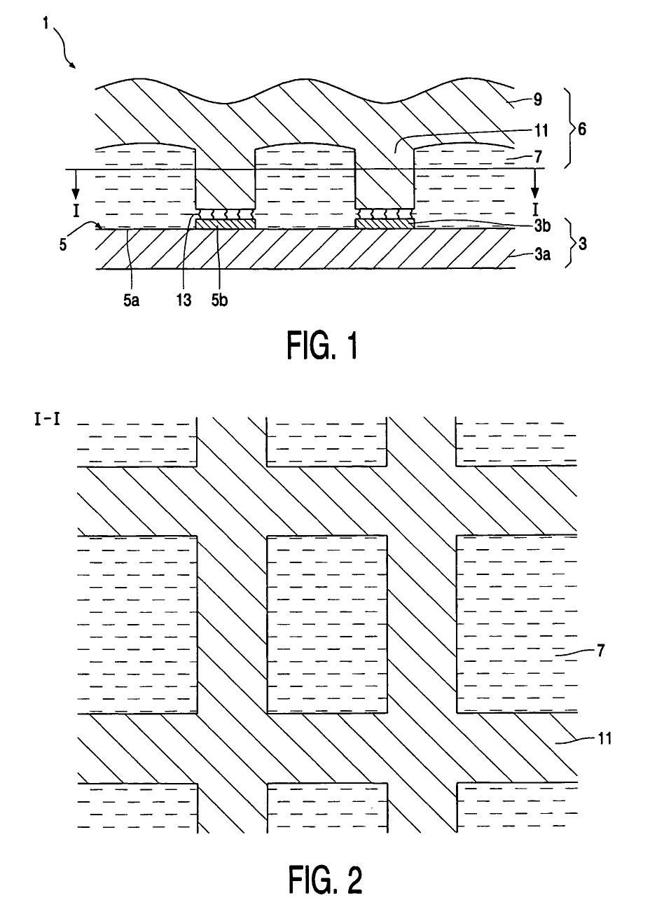

FIG. 1 shows, schematically, in a cross-sectional view, an embodiment of a polymeric stratified-phase-separated composite in accordance with the invention;

FIG. 2 shows, schematically, a plan view along the line I-I in FIG. 1;

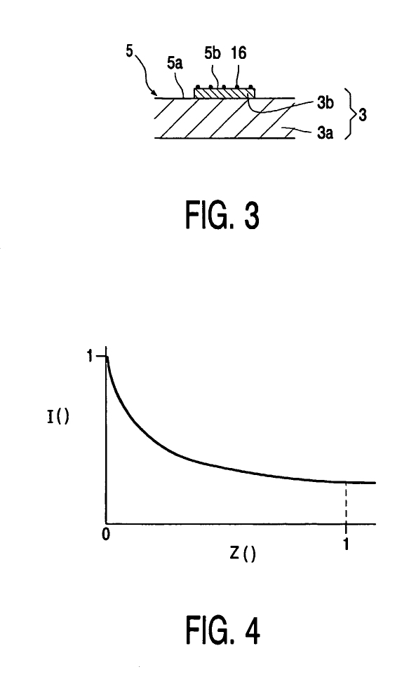

FIG. 3 shows, schematically, a first embodiment of a substrate having a surface of high and low affinity regions;

FIG. 4 shows a graph of the intensity gradient, in terms of normalized intensity of radiation I (in dimensionless units) as a function of normalized penetration depth z (in dimensionless units) set up in a layer of photo-polymerizable stratified-phase-separable material;

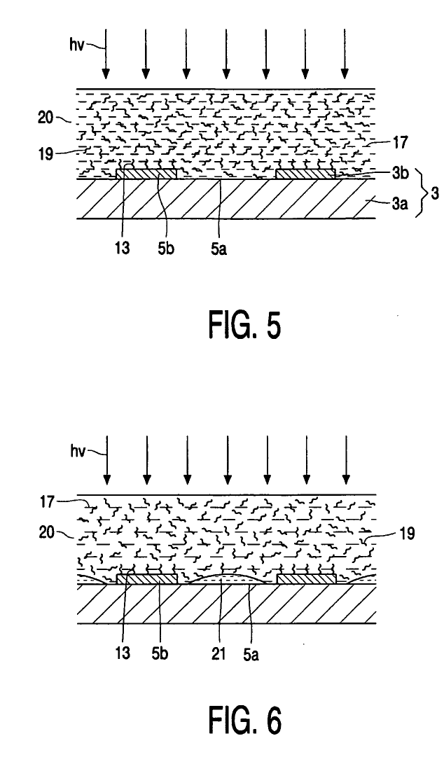

FIG. 5 shows, schematically, in a cross-sectional view, a stage of a method of manufacturing the stratified-phase-separated composite of FIG. 1;

FIG. 6 shows, schematically, in a cross-sectional view, a further stage of a method of manufacturing the stratified-phase-separated composite of FIG. 1;

FIG. 1 shows, schematically, in a cross-sectional view, a polymeric stratified-phase-separated composite in accordance with the invention. The polymeric stratified-phase-separated composite, indicated with reference sign 6, is part of a liquid-filled container 1. The polymeric stratified-phase-separated composite 6 comprises a liquid layer 7, a layer 9 of polymerized material covering the liquid film 7 and supporting members 11 which, being an integral part of the polymeric layer 9, are formed of polymerized material and extend from the polymeric layer 9 through the liquid film 7. The liquid-filled container 1 includes a substrate 3 having a substrate surface 5. The substrate comprises a base film 3a and a separate, patterned layer 3b. The surface of the patterned layer 3b provides selected first regions 5b of high affinity for polymerizable material from which the polymerized material of the supporting members is formed, is obtained. The regions of the base film 3a which are exposed to the liquid layer 7 provide second regions of low affinity 5a.

In the present embodiment, as shown in more in detail in FIG. 3, to render the surface of the patterned layer 3b a surface of high affinity, the surface of the patterned layer 3b is functionalized with chemically reactive groups 16.

The high and low affinity regions may be arranged in other ways.

In a first such other way, the substrate comprises a base film and, provided thereon, a separate, patterned layer providing the high affinity regions in accordance with the predetermined pattern. Regions of the base film which are not masked by the separate, patterned layer and exposed to the liquid layer provide the low-affinity regions.

In a second such other way, the substrate comprises a base film and, provided thereon, a separate, patterned layer providing the low-affinity regions in accordance with the predetermined pattern. The regions of the base film not masked by the separate, patterned layer provide the high affinity regions.

In a third more specific such other way, the separate, patterned layer is a mono-layer wherein the mono-layer may provide either the low or the high affinity regions.

The chemically reactive groups 16 are capable of reacting with polymerizable material from which the supporting members 11 are obtained to form covalent bonds. To this end, the polymerizable material is functionalized with chemical groups capable of reacting with the chemically reactive groups of the substrate surface, such groups may, but need not be, the same as the polymerizable groups of polymerizable material.

As shown in FIG. 1, the chemically reactive groups 16 have reacted with the chemically reactive groups of the polymerizable material to form covalent bonds 13.

For further details with respect to suitable combinations of chemically reactive groups, methods of functionalizing a substrate surface with such groups, reference is made to the companion patent application entitled “Liquid-filled container” filed in the name of Applicant and entitled to the same priority date as the present application.

In the present embodiment the difference in affinity, is brought about by having high affinity regions which are capable of covalently bonding with partially polymerized material and low affinity which are not capable of doing so. Covalent bonds are one example of chemically bonding. Other possibilities are a substrate surface with polar regions on the one hand and apolar regions on the other hand in combination with either polar or apolar polymerizable material. Ionic regions versus non-ionic regions or positively charged ionic regions versus negatively-charged regions in combination with electrically charged polymerizable material may also be used. Complexation, such as in found metal ligand complexes, may also be used as a tool for forming high and low affinity regions.

In case the container is part of a display, the layer 3b may include a black dye to, inter alia, enhance contrast. For this to be effective, the layer 3b requires a thickness of about 2 μm or more.

In addition or as an alternative to selected first and second regions 5b and 5a functionalized to provide regions of high and low affinity respectively, the selected first and second regions 5b and 5a can also be functionalized for facilitating a high and low rate of polymerization respectively. Specifically, this can be realized by selectively including in the patterned layer 3b polymerization initiator. Such polymerization initiators are well known in the art. The initiator may be selected to diffuse out of the patternred layer during polymerization, but may also be selected to remain in the patterned layer which can be realized by chemically bonding the initiator to the substrate. In case the stratified-phase-separated composite is obtained by photo-polymerization the patterned layer 3b may contain photo-initiator to make the phase-separation more selective. Preferably, in order to improve selective formation of supporting members, such photo-initiator absorbs where the stratified-phase-separable material does not absorb.

In addition or as an alternative to the presence of regions of high and low affinity and/or the selective presence of initiator, the substrate surface may be selectively functionalized with polymerization inhibitor. A high concentration of inhibitor results in a low rate of polymerization and vice versa. The initiator may be selected to diffuse out of the substrate during polymerization or can be selected to remain in the substrate, the latter case being conveniently realized by means of an inhibitor which is chemically bonded to the substrate material. Covalent bonding is preferred.

Polymerization inhibitors are as such well known in the art. Such compounds are normally added in small amounts to polymerizable compositions to prevent premature polymerization thus extending shelf life or reducing photo-degradation. Which inhibitor to use depends on the type of polymerization used. In case of free-radical polymerization, radical scavengers such as phenol group containing compounds are suitable. A cationic polymerization may be inhibited by means of an anionic compound.

Polymerizations involving (meth)acrylate monomers are inhibited by phenolic compounds such as 1,4-benzoquinone or p-methoxyphenol.

A high concentration of polymerization inhibitor is typically 0.1 to 5 wt % in relation to the polymerizable material.

In case the substrate material in which the polymerization inhibitor is to be included is a polyimide, inhibitors having lower volatility than 1,4-benzoquinone or p-methoxyphenol are preferably used because polyimide processing requires relatively high temperatures. Obviously, volatility is reduced to a minimum if the polymerization inhibitor is chemically bonded, more specifically covalently bonded to the substrate material.

Further examples of suitable inhibitors include tert-butyl catechol, phenothiazine, N,N′-bis-sec-butyl-p-phenylene diamine, p-nitrosophenol, 2,2,6,6-tetramethyl-1-oxyl-piperidine (TEMPO) and 4-acetoxy-2,2,6,6-tetramethyl-1-oxyl-piperidine (4-acetoxy-TEMPO).

The thickness of the layer of polymerized material 9 can be anything between 1 and 200 μm, or better 2 to 150 μm, or still better 3 to 100 μm. A preferred range is 5 to 50 μm, or even more preferred 10 to 40 μm.

The thin liquid film 7 has a thickness typically less than about 5 mm, or more specifically, about 1 mm. It may even have a thickness of about 500 μm, or more particular about 200 μm or less. The minimum thickness is about 0.5 μm or more particular about 1.0 μm. If a liquid crystal layer is used, the thickness is about 0.5 to 20 μm or preferably 1 to 10 μm.

The patterned layer 3b has a thickness typically ranging from about 1 nm, in the case of a monolayer, to about 100 μm.

Use of a stratified-phase-separated composite has the advantage results in liquid-filled containers which are thin, much thinner than those comprising separate sheets. This renders the liquid-filled container particularly flexible while maintaining mechanical robustness.

Polymeric stratified-phase separated composites, methods of obtaining such and materials from which such composites can be obtained are known in the art as such. See e.g. U.S. Pat. No. 6,486,932, WO 02/42832, WO 02/48281, 02/48282 and 02/48783. Such known composites, methods and materials can be suitably used in the present invention.

The base film 3a may be formed of in principle any kind of material capable of containing the liquid. Depending on the application it may be impermeable or permeable to the liquid contained. The substrate 3 may be made of metal, ceramic, glass or other inorganic material. If the liquid-filled container is to be flexible, synthetic resin is a good choice. Combinations of such materials such as in the form of a laminate can also be used. The base film may need to have functionality other than that of holding the liquid depending on the application. For example, if the liquid-filled container is used in an optical application wherein the container needs to be transmissive, the base film may need to be transparent. If the liquid-filled container is used as part of a liquid crystal display the base film would typically comprise a variety of layers such as an alignment layer for aligning the liquid crystal, electrode layer(s) and polarizer layer(s).

The base film typically has a thickness of less than about 5 mm, often less than about 2 mm. A convenient thickness is about 1 mm or less. If a large thickness is used, flexibility is impaired, weight increases and relatively less liquid can be accommodated. On the other hand if the thickness becomes too small, say less than about 10 μm, or better less than about 20 μm, the sheet becomes very fragile and hence easily damaged when handled during use or manufacture of the liquid-filled container.

The liquid-filled container in accordance with the invention may, in a broad sense, contain any type of liquid. The liquid may be an inorganic liquid such as water or may be of organic origin. The liquid may be an oil, a paste, a cream, a foam, an ink, an emulsion, a colloid, a suspension or other form liquid containing particles. Depending on the application the liquid may contain functional particles or additives such as dyes, pharmaceuticals or ions.

The supporting members 11 are laid out in accordance with a predetermined pattern. In the broadest sense, any pattern may be used so as to obtain for example a plurality of separate supporting members positioned at regular distances on the substrate surface or ribs and networks of ribs or pillars extending throughout the liquid layer such that all the liquid is still in contact.

Also, separate pockets of liquid may be formed by having supporting members laid out as a connected grid.

FIG. 2, shows, schematically, a top view of the liquid-filled container of FIG. 1 along the line I-I. In this embodiment, the supporting members 11 are laid out as a rectangular connected grid of walls partitioning the liquid layer 7 into a plurality of separate rectangular liquid-filled pockets. Instead of rectangular (square) the liquid-filled pockets may be hexagonal, triangular or round such as circular. Supporting members laid out on a connected grid provide the liquid-filled container with exceptional robustness allowing very thin and thus flexible liquid-filled containers to be constructed. Moreover, since the pockets are separated from one another by the supporting members no liquid can flow from one pocket to another. This has the advantage that a constant thickness of the liquid-filled container, in particular a constant liquid film thickness, can be maintained even when local pressure is applied to a major surface of the container. For many applications, display applications being a particular example, this is an attractive property.

The supporting members extend from the polymeric layer 9 to the substrate 3 thus providing mechanical robustness to the liquid-filled container. The supporting members substantially determine the distance between the sheets and the thus the volume of liquid which can be accommodated. If provided in sufficient density the thickness is maintained when compressive forces are applied at right angles to the sheets. The supporting members also provide resistance against shear and lateral stresses. Because the supporting members are bonded to the substrate via high affinity regions, the supporting members are firmly attached to the substrate surface rendering the liquid-filled container and stratified-phase-separated composite mechanically very robust.

The height of the supporting members is commensurate with the desired liquid film thickness. The width of the supporting members and the volume occupied by the supporting members depends on the application. Typically, to facilitate the patterning process, the width of the supporting members should be more than about 0.1 μm, or, better, 0.2 μm, or still better, 0.5 μm. Supporting members having a width of about 1.0 μm or larger are preferred. Depending in the application the width may be about 5 μm or larger or even about 10 μm or larger. Maximally, the width is about 100 μm or better 60 μm. Optimizing for mechanical strength requires the aspect ratio to be at least 0.5 or better at least about 1.0, aspect ratio being defined as width to height ratio. A comfortable aspect ratio is about 5 or more or better about 10 or more. The volume occupied by the supporting members is preferably about 1% to 20% of the total volume between the substrate 3 and the polymeric layer 9.

The liquid-filled container generally has sealing means (not shown in FIG. 1) running along the perimeter thereof to prevent the liquid from leaking out sideways. Conventional sealing means, such as glue or tape or rubber or metal gasket, may be used for this purpose. Supporting members may also be used to form the sealing means.

A method of manufacturing the liquid-filled container shown in FIG. 1 comprises:

In a first step a substrate 3 is provided which comprises a base film 3a provided with a separate, patterned layer 3b. The surface of the separate patterned layer 3b has regions 5b functionalized with chemically reactive groups 16, the regions 5b being laid out in accordance with a predetermined pattern (see FIG. 3). Surface regions of the base film 3a not covered by the patterned layer 3b provide non-reactive regions 5a (see FIG. 3). The chemically reactive groups 16 are capable of reacting with corresponding chemically groups of the polymerizable material from which the polymerized material of the stratified-phase-separated composite is obtainable, to form the covalent bonds 13 (see FIG. 1) and are thus regions of high affinity. The high affinity is expressed when the covalent bonds are formed. The regions 5a which are not so functionalized are regions of low affinity. Using such chemically reactive groups is but one way of providing regions of differing in affinity. As elaborated upon hereinabove, other possibilities are available.

A second step is to provide the substrate surface 5 having the low and high affinity regions 5a and 5b with a polymeric stratified-phase-separable material. In the present embodiment, use is made of photo-polymeric stratified-phase-separable material where phase-separation can be induced by means of UV radiation. However, this is not essential. Alternatively, use can be made of solvent or temperature induced stratified-phase-separable material such materials being known in the art as such.

To bring about stratification, the present embodiment uses an intensity gradient of radiation as further detailed hereinbelow. Other stratification methods may be used as well such as those based on differential wetting, see U.S. Pat. No. 6,486,932.

The photo-polymerizable stratified-phase-separable material comprises a liquid from which the liquid phase of the stratified-phase-separated composite is to be formed and a photo-polymerizable material from which the polymeric phase is to be formed.

(Photo)-polymerizable stratified-phase-separable material is known in the art as such, see e.g. U.S. Pat. No. 6,486,932, WO 02/42832, WO 02/48281, 02/48282 and 02/48783. These known materials can be suitably used in the method in accordance with the invention. Further stratified-phase-separable materials which may be suitably used in the method in accordance with the invention are described in the companion patent application entitled “Liquid-filled container” filed in the name of Applicant and entitled to the same priority date as the present application.

Optionally, the polymerizable stratified-phase-separable material includes a polymerization initiator, a thermal such as dicumyl peroxide, optionally activated by an amine, or photo-initiator more in particular. If the amine activator diffuses into the layer of polymerizable stratified-phase-separable material during polymerization from the side facing away from the substrate, stratification is particularly good. If e-beam is used, for example in the form of an e-curtain, to bring about polymerization and thus stratification an initiator can be dispensed with.

In the present embodiment, the photo-polymerizable stratified-phase-separable material contains chemically reactive groups capable of reacting with the chemically reactive groups of the high affinity regions 5b. Suitable combinations of chemically reactive groups which can react with one another to form covalent bonds are described in the companion patent application entitled “Liquid-filled container” filed in the name of Applicant and entitled to the same priority date as the present application. In the present embodiment the polymerizable groups of the polymerizable materials are capable of reacting with the chemically reactive groups of the high affinity regions.

In a third step of the method, the layer of stratified-phase-separable material is subjected to a flood exposure with UV light. The photo-polymerizable stratified-phase-separable material is adapted to absorb the UV radiation as a result of which an intensity gradient is set up in a direction transverse to the layer.

FIG. 4 shows a graph of the intensity gradient, in terms of normalized intensity of radiation I (in dimensionless units) as a function of normalized penetration depth z (in dimensionless units) set up in a layer of photo-polymerizable stratified-phase-separable material. A penetration depth of 0 corresponds to the major surface of the layer of stratified-phase-separable material closest to the source of radiation, whereas a penetration depth of 1 corresponds to the interface with the substrate surface 5.

The absorption of radiation by the layer is adapted such that a significant amount of radiation is able to reach the substrate surface 5, in particular the high affinity regions thereof.

The mechanism of stratified phase separation when a substrate surface having selected regions of high and low affinity is used, is discussed using FIGS. 5 and 6.

FIG. 5 shows, schematically, in a cross-sectional view, a stage of a method of manufacturing the stratified-phase-separated composite of FIG. 1.

The stage shown is an initial stage of irradiation of the stratified-phase-separable material 17 provided on a substrate having selected first and second regions of high and low affinity. In such initial phase the irradiation induces polymerization of the monomeric material to form partially polymerized material 19. At this initial stage the polymerized material is still fully miscible with the liquid material 20. Prior to phase separation, the extent to which polymerization has occurred is believed to be constant throughout the layer at each given penetration depth because the intensity profile is the same along any axis transverse to the layer if possible differences on absorption between monomeric and partially polymerized material are neglected. In directions transverse to the layer, the intensity gradient has brought about a gradient in extent of polymerization, extent of polymerization being highest nearest the radiation source. The gradient in extent of polymerization drives migration of monomeric and partially polymerized material in directions towards the radiation source and migration of liquid material away therefrom. However, adjacent the interface of the high affinity regions polymerizable material reacts with the chemically reactive groups of the high affinity regions 5b to form covalent bonds 13 thus adhering the partially polymerized material strongly to the substrate surface and preventing migration of the polymerizable material so bonded.

FIG. 6 shows, schematically, in a cross-sectional view, a further stage of a method of manufacturing the stratified-phase-separated composite of FIG. 1.

As polymerization proceeds, the molecular weight of the partially polymerized increases and eventually becomes so large that the partially polymerized material is no longer miscible with the liquid which marks the beginning of phase-separation. Since the extent of polymerization is highest in regions nearest to the radiation source, phase-separated liquid—which is far more mobile than the partially polymerized material—is pushed away from such regions towards the substrate surface thus forming drops of pure liquid 21 near the substrate surface which are covered with a polymeric layer. The polymeric layer being formed still contains a certain amount of liquid. In forming the pure liquid, drops of partially polymerized material need to be pushed out of the way. However, in the high affinity regions the partially polymerized material adheres strongly to the substrate surface and cannot be pushed out of the way. As a result, drops of liquids cannot form in regions adjacent the high-affinity regions. As the polymerization proceeds, this becomes more and more difficult. At a certain stage, phase-separation will occur in regions adjacent the high-affinity regions thus forming the supporting members in accordance with the predetermined pattern the high affinity regions are laid out in.

When phase-separation is complete, the polymeric stratified-phase-separated composite having the supporting members extending onto the substrate surface in accordance with a predetermined pattern is obtained.

A substrate sheet 3 having the patterned layer 3b on top of the base film 3a as shown in FIG. 3 may be manufactured by printing the patterned layer 3b on top of the base film 3a. Any printing method may be used for this purpose such as ink jet printing, off-set printing, tampon printing, flexo printing, screen printing and the like. A convenient printing method is micro contact printing. Subtractive deposition methods wherein patterned (photo)resists are deposited may also be used but are not preferred if the base film 3a is sensitive to the processing steps involved.

In order to obtain a mechanically robust stratified-phase-separated composite, the patterned layer 3b should adhere well to the base film 3a. In the sheet shown in FIG. 3, the pattern layer 3b adheres physically to the base film 3a. Conventional methods to improve adhesion may be used if adhesion is found to be insufficient. Examples of such methods and tools have been described hereinabove with respect to the provision of high and low affinity regions. An effective method to improve physical adhesion is to use a solvent in the deposition of the patterned layer which attacks the base film as a result of which, at the interface, patterned layer material can diffuse into the base film material and vice versa. This works particularly well if the base film and patterned layer are polymeric because then the polymer chains may get entangled providing a seamless interface. For example, a polyimide base film can be made to strongly adhere to a patterned polyamic ester layer. Alternatively, the patterned layer may be covalently bonded to the base film.

Preferably, the polymeric stratified-phase-separated composite comprises a thin film of liquid crystal, more particular a film of liquid crystal which is can be brought into states of different optical properties. States having different optical properties can be obtained by using a switchable orienting liquid crystal film. Such films are known in the art as such. A preferred means to orient a liquid crystal film is an alignment layer which is provided on the substrate 3. Suitable alignment layers are polyimide alignment layers but nylon or polyvinylalcohol alignment layers may also be used. Photo-alignment layers may also be used, such as a photo-sensitive polyimide, a polyvinylcinnamate or a coumarin containing polymer.

Liquid-filled containers comprising (oriented) liquid crystals which can be switched between states of having different optical properties can be suitable used in liquid crystal displays. In such a case the first sheet and optionally the second sheet will have a composite structure including besides alignment layers, electrode layers, retardation, color filter layers, active matrix circuitry and the like. With respect to a polymeric stratified-phase-separated composite comprising containers used in displays reference is made to WO 02/42832.

### EXAMPLE 1

A thin liquid-filled container as shown in FIG. 1 is manufactured as follows:

A glass substrate provided with active matrix in-plane switching circuitry is coated with a polyimide layer (AL 3046, JSR) which is then rubbed to obtain an alignment layer, the combination forming a composite base film 3a.

A patterned layer 3b is formed by micro-contact printing, more particularly by providing in a first step a glass substrate with a layer of a photo-sensitive polyamic ester (Durimide 7505, Arch Chemicals) by means of spin-coating (10 s at 100 rpm, 30 s at 3000 rpm). The structural formula of the polyamic ester is:

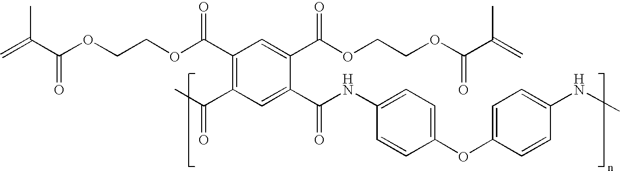

In a second step, a polydimethylsiloxane stamp provided with a 4 by 5 cm square grid pattern wherein the grid lines are each 50 μm wide, each 100 μm high and spaced 500 μm apart in both directions (heart to heart distance) is inked by contacting the stamp with the wet polyamic ester layer and then contacting the inked stamp with the base film 3a on the alignment layer side thus transferring the ink onto the base film 3a. After removal of the stamp, the inked base film 3a is heated on a hot plate at 90° C. for about 10 minutes to evaporate the solvent thus obtaining a substrate 3 as shown in FIG. 3. The substrate 3 comprises a base film 3a and provided thereon a separate, patterned layer 3b of polyamic ester, the separate, patterned layer 3b having a surface provided with high affinity regions 5b. The regions 5b have acrylate groups as chemically reactive groups 16. The alignment layer surface exposed by the layer 3b is not so functionalized and form the low-affinity non-reactive regions 5a.

The predetermined pattern of the patterned layer 3b is similar to that shown in FIG. 2 and is a square grid, each grid line being 50 μm wide and 500 μm (heart to heart distance). Its thickness is about 150 nm.

Using an Erichsen doctor blading apparatus, the substrate 3 is provided with a thin (about 30 μm) film of a photo-polymerizable stratified-phase-separable material of the following composition: 50 wt % liquid crystal E7 (a mixture of several cyano-substituted biphenyls and a cyano-substituted terphenyl, marketed by Merck), 44.5 wt % isobornylmethacrylate (supplied by Sartomer), 0.5 wt % photo-initiator Irgacure 651 (Ciba Geigy) and 4.5 wt % of (E)-4,4′-di-(6-methacryloyloxyhexyloxy)-3-methylstilbene synthesized as described WO 02/42832.

The photo-polymerizable stratified-phase-separable material has methyacrylate groups. The patterned layer 3b provides regions functionalized with methacrylate groups. Methacrylate groups are capable of reacting with another. Thus, the photo-polymerizable material has chemically reactive groups which are capable of reacting with the chemically reactive groups of the patterned layer 3b.

The thin layer of stratified-phase-separable material is subjected to a flood exposure using ultraviolet light (Philips TL08, 0.3 mW/cm²) at a temperature of 50° C. in a nitrogen atmosphere for 30 minutes. The UV photons induce polymerization of the methacrylate monomers. As polymerization proceeds partially polymerized material of increasing molecular weight is formed. At the point where partially polymerized is not miscible any more with the liquid crystal, phase-separation occurs. The stratified-phase-separable material absorbs the UV radiation (substantially by means of the stilbene compound and the photo-initiator) and an intensity gradient is established, the highest intensity in regions nearest to the radiation source. This gradient is the driving force of stratification. The absorption of the film of stratified-phase-separable material is such that UV photons also reach the interface of the patterned layer 3b and the film of stratified-phase-separable material, thus initiating reaction between methacrylate groups of the stratified-phase-separable material and the methacrylate groups of the patterned layer 3b. As a result of this reaction, covalent bonds are formed between the patterned layer 3b and the polymerizable material from which the supporting members are obtained.

After irradiation, a stratified-phase separated composite 6 is formed. The composite 6 comprises a thin oriented liquid crystal film 7 of separate LC pockets of approximately hemispherical shape each having a maximum thickness of 10 μm. The composite 58 further comprises a solid polymeric layer 9 from which supporting members 11 extend onto the substrate 3.

The liquid-crystal filled liquid container so obtained is examined under a polarization microscope. The pockets filled liquid crystal 7 and the supporting member sections 11 are clearly distinguishable: In some areas, birefringent effects are observed indicative of the presence of oriented liquid crystal, whereas in other areas the image is consistent with what is normally observed for optically isotropic material, indicating that in such areas supporting member material is present.

The liquid-crystal filled container forming the display so obtained has oriented liquid crystal which can be switched by means of the active matrix in-plane switching circuitry to display an image. Exerting pressure on the display at the viewing side with a finger does not result in any image distortion as would be observed in conventional LC displays evidencing the excellent mechanical robustness of the display in accordance with the invention.

Furthermore, after heat stressing the display at 90° C. for several hours the display is still operational. Conventional displays comprising stratified-phase-separated composites, that is those having supporting members 59 which are not covalently bonded to the sheet 3 do not survive such test.

### EXAMPLE 2

A liquid-filled container identical to that of Example 1 is manufactured except that, instead of a glass substrate with active matrix circuitry, a polymer substrate (an engineered polycarbonate foil from Teijin, type DT 120 B 60) designed for use in plastic LCDs is used.

When the container is examined under a polarization microscope substantially the same image as is observed in Example 1, is observed so far as the supporting member and liquid crystal layer is concerned.

The liquid-filled container is then subjected to a flexure test by flexing, by hand, the container to a radius of curvature of about 1 cm. This is repeated at least 20 times.

Thereafter, the liquid-filled container is again examined with a polarisation microscope. The image observed is substantially the same as that observed before the flexure test clearly indicating the mechanical robustness of the liquid-filled container in accordance with the invention.

### EXAMPLE 3

(not in accordance with the invention)

Example 2 is repeated with the difference that instead of providing the patterned layer 3b, a pattern-wise exposure is used to obtain the supporting members in accordance with the predetermined pattern. Hence, the substrate 3 does not have regions of low and high affinity.

Specifically, in the pattern-wise exposure, the film of stratified-phase-separable material is irradiated through a mask with a high-intensity light near-UV source (Philips UHP, 10 mW/cm²) for 3 minutes in a nitrogen atmosphere. The distance between UV source and the mask is about 40 cm, distance between the mask and the film is 1 mm. In the light path a diffuser is placed (10 cm from the UV source) to obtain more homogeneous illumination conditions. During the pattern-wise exposure, a square grid of supporting members 11 is formed.

In the second flood exposure, the film is exposed to near-UV light of much lower intensity (Philips TL08, 0.3 mW/cm²) at a temperature of 50° C. in a nitrogen atmosphere. In this exposure, the phase-separable material between the supporting members phase-separates in a stratifying manner thus forming the polymeric layer 9 and the liquid crystal layer 7.

The liquid-filled container so obtained is examined by polarization microscopy. An array of separate liquid crystal filled pockets is observed enclosed by a square grid of supporting members 11 laid out in accordance with the pattern of the pattern-wise exposure.

The liquid-filled container so obtained is subjected to the flexure test of Example 2.

After the flexure test, the liquid-filled is again examined with the polarization microscope. It is observed that a significant proportion of the supporting members 11 have been dislodged from their original position. The liquid crystal pockets are no longer nicely separated, liquid crystal can flow from pocket to another. This dramatically affects the (electro) optical properties of the container, such as its contrast and color point of the bright state, as well as its mechanical properties of the layers, such as the capability to maintain a constant liquid film thickness when pressure is applied and resistance against lateral forces.

### EXAMPLE 4

A liquid crystal display having a liquid-filled container as shown in FIGS. 1 and 2 is manufactured as follows:

A polymer foil (an engineered polycarbonate foil from Teijin, type DT 120 B 60) is provided with an in-plane switching ITO electrode structure. The electrodes can be addressed by direct addressing. The polymer foil is on the electrode side coated with a silicon nitride (SiNₓ) passivation layer of about 100 nm thickness. On top of the nitride layer a polyimide alignment layer (AL 3046, JSR) is provided, completing the manufacture of the composite base film 3a.

In accordance with the method of Example 1, the base film 3a is provided with a patterned layer 3b of polyamic ester having methacrylate groups. The substrate 3 so obtained has high-affinity regions functionalized with chemically reactive groups. The patterned layer is laid out in a square grid with 50 μm wide lines and 500 μm apart (heart to heart distance).

Using the method of Example 1, the first sheet 3 is provided with an about 30 μm thin film of stratified-phase-separable material having the composition: 50 wt % liquid crystal material E7 (Merck), 44.5 wt % isobornylmethacrylate (Sartomer), 0.5 wt % photo-initiator Darocure 4265 (Ciba Geigy), 5.0 wt % (E)-4,4′-di-(6-methacryloyloxyhexyloxy)-3-methylstilbene. Exposure with UV light (Philips TL08, 0.3 mW/cm²) at a temperature of 50° C. in a nitrogen atmosphere for 30 minutes results in the formation of a stratified phase-separated composite 6 having a polymeric layer 9, supporting members 11 and liquid crystal layer 7.

On the polymeric layer 9, an about 20 μm thick planarizing layer of tripropylene glycol diacrylate is applied using a doctor blade. The planarizing layer is cured with UV light (Philips HPA: 4 mW/cm², 10 minutes). Finally, two coatable water-born polarizers (Optiva Inc.) are coated with the Mayer's Rod coating technique on each side of the layer stack: one on top of the planarizing layer, the other on the back of the substrate 3.

The LC display so manufactured is rolled up on a cylinder with a radius of 1 cm and unrolled again. This is repeated over a thousand times. During such time the LC display is continuously addressed to display an image. During a cycle of the flexure test the image displayed does not change. Furthermore, during the flexure test, no degradation of the image displayed is observed. This evidences the excellent mechanical robustness of the display in accordance with the invention.

### EXAMPLE 5

A thin liquid-filled container as shown in FIG. 1 is manufactured using the method of Example 1 with the following differences:

1) The base film 3a is a poly-imide layer (AL 3046, JSR) which is modified with 3 wt % 4-acetoxy-TEMPO inhibitor and cured at 150° C. for 30 minutes. This results in selected regions 5b functionalized with polymerization inhibitor thus reducing the rate of polymerization in areas adjacent such regions 5b compared to the regions 5a which are not so functionalized.

2) Instead of (E)-4,4′-di-(6-methacryloyloxyhexyloxy)-3-methylstilbene which absorbs the UV light by means of which polymerization is brought about, UV transparent tripropyleneglycol dimethacryalate is used.

Since no UV absorbing compound is used, no intensity gradient is set up within the layer being phase separated. Accordingly, the driving force for stratification derived from such an intensity gradient is not operative. Nevertheless, excellent stratification is observed which is attributed to the selective presence of the polymerization inhibitor in the selected second regions 5.

1. A polymeric stratified-phase-separated composite comprising a film of a liquid, a layer of a polymerized material covering the film of liquid and supporting members formed of the polymerized material and extending from the layer of polymerized material through the film of liquid, the polymeric stratified-phase-separated composite being provided, with its film of liquid side, on a substrate surface having in accordance with a predetermined pattern selected first and second regions, the first regions being functionalized for selective accumulation of the polymerized material and the second regions being functionalized for selective accumulation of the liquid, wherein the supporting members extend selectively onto the selected first regions.

2. A polymeric stratified-phase-separated composite as claimed in claim 1 wherein the selected first and second regions are regions of high and low affinity, respectively, for polymerizable material from which the polymerized material of the supporting members is obtained.

3. A polymeric stratified-phase-separated composite as claimed in claim 2 wherein the regions of high affinity are functionalized with chemically reactive groups and the regions of low affinity are not so functionalized, and regions of the supporting members are functionalized with chemically reactive groups, and chemically reactive groups of the substrate surface and the supporting members having reacted with one another to form covalent bonds.

4. A polymeric stratified-phase-separated composite as claimed in claim 1, wherein the first and second regions are functionalized for facilitating a high and low rate of polymerization respectively.

5. A polymeric stratified-phase-separated composite as claimed in claim 4 wherein the high and low rate of polymerization is facilitated by means of a low and high concentration of polymerization inhibitor respectively.

6. A polymeric stratified-phase-separated composite as claimed in claim 1, wherein the polymeric stratified-phase-separated composite is a photo-polymeric stratified-phase-separated composite.

7. A polymeric stratified-phase-separated composite as claimed in claim 1, wherein the supporting members are formed as walls partitioning the film of liquid into a plurality of separate liquid-filled pockets.

8. A polymeric stratified-phase-separated composite as claimed in claim 1, wherein the liquid is a liquid crystal.

9. A polymeric stratified-phase-separated composite as claimed in claim 8 wherein the substrate surface is, on a side facing the film of liquid, provided with an alignment layer.

10. A liquid crystal display comprising a polymeric stratified-phase-separated composite as claimed in claim 8.

11. A method of manufacturing a polymeric stratified-phase-separated composite comprising a film of a liquid, a layer of polymerized material covering the film of liquid and supporting members formed of polymerized material and extending from the layer of polymerized material through the film of liquid onto selected first regions of a substrate surface, the method comprising:
providing a substrate surface having, in accordance with a predetermined pattern, selected first and second regions, the first regions being functionalized for selective accumulation of the polymerized material and the second regions being functionalized for selective accumulation of the liquid;
providing onto the substrate surface, a layer of polymerizable stratified-phase-separable material;
obtaining the polymeric stratified-phase-separated composite from the polymerizable stratified-phase-separable material by inducing polymerization of the polymerizable stratified-phase-separable material at least at locations where the layer of polymerizable stratified-phase-separable material is adjacent to the first regions.

12. A method as claimed in claim 11 wherein the polymerizable stratified-phase-separable material is photo-polymerizable.

13. A method as claimed in claim 12 wherein the photo-polymerization is induced by means of a flood exposure.
